(19) United States
(12) Patent Application Publication
(10) Pub. No.: US 2009/0304370 A1
(43) Pub. Date: Dec. 10, 2009

(54) DEVICE AND METHOD FOR CONTROLLING INFRARED LAMP OVENS

(76) Inventor: Alain Dupuis, Geneva (CH)

Correspondence Address: FROMMER LAWRENCE & HAUG LLP, 745 FIFTH AVENUE, NEW YORK, NY, 10151, US

(21) Appl. No.: 12/473,453

(22) Filed: May 28, 2009

(30) Foreign Application Priority Data
Jun. 9, 2008 (FR) 08 03195

(51) Int. Cl. H05B 1/02; H05B 6/00

(52) U.S. Cl. 392/407; 219/497

(57) ABSTRACT

The present invention relates to a device for controlling at least one heater (6) within an installation for preheating the preforms used in the manufacture of plastic containers. The device comprises: at least one detection means (3) connected in series with said heater (6) and with a first power switch (4), and enabling the current and/or voltage to be measured; and at least one second power switch (5) connected in parallel with said first power switch (4) and controlled by a control card (8), said control card (8) being designed to divert, as soon as a current exceeding a threshold value is detected in said detection means (3), the current into said second power switch (5). The invention also relates to a corresponding control method and a corresponding preheating installation.

### BACKGROUND OF THE INVENTION

The present invention relates in general to the field of manufacturing plastic containers, especially to the treatment of the preforms used in the process for manufacturing these containers, and specifically has the objective of providing a device and a corresponding method for controlling an infrared heater used in this context.

### DESCRIPTION OF THE PRIOR ART

Currently, plastic containers, typically polyethylene terephthlate (PET) bottles for example, are normally manufactured by stretch-blow molding a preform heated beforehand to a temperature of around 100° C. A preferred means of preheating the preforms consists of lamps radiating in the infrared spectrum past which the preforms run. The infrared radiation is generally produced by tungsten filaments located in the lamps, which filaments, once a controllable current is flowing through them, radiate with a given intensity and thus heat the preforms.

The preforms may have different shapes and thicknesses depending on the container to be produced. Consequently, the operating parameters for such an infrared lamp and the treatment carried out in the stretch-blow molding device vary depending on the characteristics of the preform. Moreover, to ensure that the preform is properly heated through the thickness of its wall and along its profile, as a general rule the preforms run past a succession of independent ovens, each equipped with several horizontally positioned infrared lamps. The operating parameters for each of these lamps are controlled independently by a control device, the electronics of which can be programmed according to said characteristics of the preform.

In particular, the control device usually called an electronic regulator, is used to run the lamps of an oven off an industrial AC supply. The electronic regulator is generally supplied by the industrial single-phase AC power supply and is connected to a central control system via an area bus. Depending on the commands and setpoints received from the central control system via the area bus, the regulator controls each lamp according to a suitable regulating algorithm and furthermore returns, to the central control system, all the relevant information collected from the lamps.

This kind of electronic regulator normally comprises electronic power switches, these being controlled by an electronic control unit and enabling the current in the infrared lamps to be controlled for each half-cycle of the AC supply. The electronic power switches designed to manage the power delivered to the infrared lamps used in said preheating ovens are often thyristors, IGBTs (insulated-gate bipolar transistors) or other semiconductor switches using other technologies suitable for this purpose.

Given that this typical configuration of an installation for preheating plastic preforms for the purpose of subsequently processing them using a stretch-blow molding device, it should be noted that the infrared lamps, especially their tungsten filaments, represent a weakness that quite often results in a short-circuit in the installation. Other phenomena may lead to the same result, whereby very high current flows through the circuit of the control device and runs the risk of damaging many components by depositing at least some of its thermal energy as it passes through these components. In particular, it frequently happens that said electronic power switches are destroyed by a short-circuit caused by an infrared lamp breaking.

In particular to avoid the electronic power switches in particular being damaged, it is conventional to provide fast-acting fuses upstream of the elements sensitive to sudden variations and short-circuit values of the current. This protection method is simple and effective, but has the major drawback of requiring the fuses to be changed after each short-circuit.

It is also possible to replace the fast-acting fuses with electromechanical circuit breakers that can be reset after a short-circuit. However, these are slower than fuses and thus decrease the absolute protection of the electronic switches or other components of the control device. Moreover, the extreme short-circuit current values on high-power industrial plants often make it impossible to protect electronic switches or other power components by means of fuses or fast-acting circuit breakers owing to the threshold values that can be withstood by these elements being exceeded.

Alternatively, it is also known to protect the components of the control device, especially the electronic power switches, by an electronic power circuit breaker. This method has the advantage of cutting off the current in a very short time and of providing good protection, but it has the disadvantage that the nominal current of the installation flows through the circuit breaker. The latter therefore suffers a voltage drop linked to its structure considered as a semiconductor, with the undesirable result that it heats up substantially.

The object of the present invention is to obviate the aforementioned drawbacks of the known solutions and to provide a control device and a corresponding control method for simple and effective protection of the components of such a device for controlling a preheating installation comprising in particular an infrared heater.

### SUMMARY OF THE INVENTION

Thus, one subject of the invention is a control device, for controlling at least one heater within an installation for preheating the preforms used in the manufacture of plastic containers, the device comprising at least a first power switch connected in series with said at least one heater; and a control card for independently regulating the current intensity through each heater by means of the corresponding first power switch, the device being noteworthy in that it further comprises at least one detection means connected in series with said heater and with said first power switch and enabling the current and/or voltage to be measured; and at least one second power switch connected in parallel with said first power switch and controlled by said control card, said control card being designed to divert, as soon as a current exceeding a threshold value is detected in said detection means, the current into said second power switch.

This kind of device provides the components, especially the power switches, with effective protection from damage following a short-circuit, without correspondingly generating heat during normal operation. In addition, the reaction time is very rapid.

Normally, this kind of control device may be supplied by an industrial AC power supply.

The first power switch and the second power switch may consist of a thyristor or an insulated-gate bipolar transistor (IGBT). Preferably, the first and second power switches have a thermal capacity of between 400 A²s and 900 A²s and between 15 000 A²s and 35 000 A²s, respectively.

Moreover, the control device normally includes at least one electromechanical circuit breaker connected in series with said detection means, with said at least one first power switch and with said at least one heater.

Said at least one detection means may consist of a Hall detector and as a general rule said control card is connected to a central control system.

Another subject of the invention is an installation for preheating the preforms used in the manufacture of plastic containers, which comprises at least one heater and at least one such control device. Often, each heater consists of a lamp emitting radiation in the infrared spectrum. The preform preheating installation may also consist of a succession of independent ovens, each having at least one infrared lamp, each of the lamps of an oven being able to be independently controlled and protected by said control device.

Finally, another subject of the invention is a control method for actuating such a control device or such a preheating installation, the method including the step of regulating the current through each heater by means of the corresponding first power switch connected in series with said heater, the method being distinguished in that it further includes the steps of monitoring the current measured by the detection means connected in series with said heater and said power switch; and as soon as a current exceeding a threshold value is detected in said detection means, diverting the current into the second power switch connected in parallel with said first power switch.

The control method may further include the step of blocking the first power switch and the second power switch at the end of the AC half-cycle during which a current exceeding a threshold value has been detected and/or the step of cutting off the power supply by means of said electromechanical circuit breaker as soon as a current exceeding a threshold value is detected in said detection means.

### BRIEF DESCRIPTION OF THE DRAWING

The appended drawings show, schematically and by way of example, one embodiment of the invention.

FIG. 1 is a schematic view of a control device according to the present invention which enables a heater used in a preform preheating installation (not shown) to be controlled.

### DESCRIPTION OF THE PREFERRED EMBODIMENT

The invention will now be described in detail with reference to the appended drawings, which illustrate by way of example an embodiment of the invention.

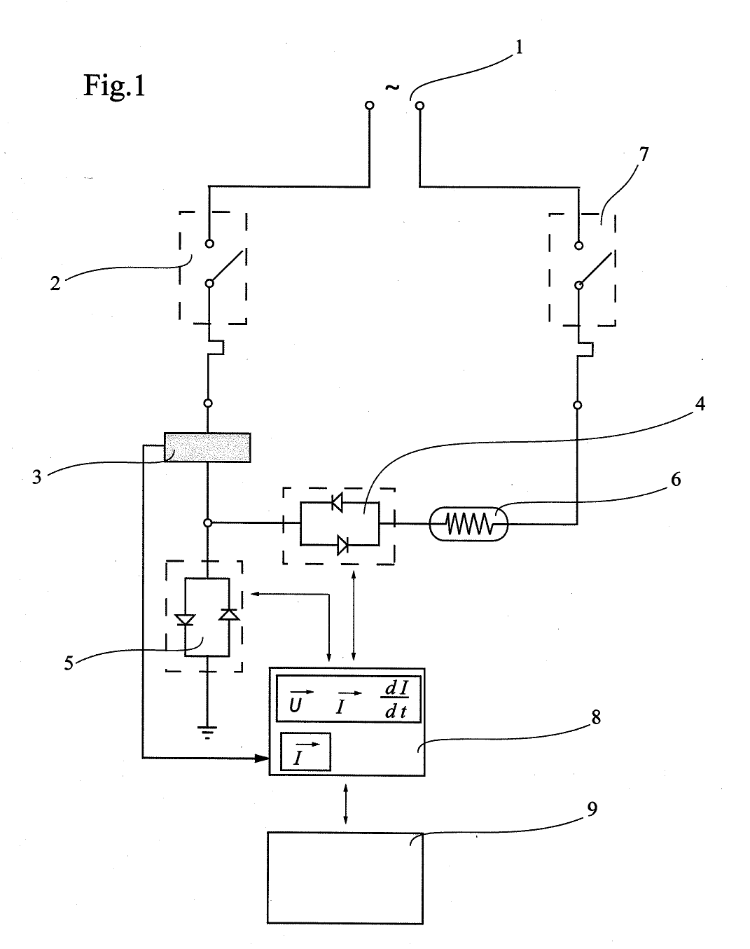

FIG. 1 shows schematically a device for controlling at least one heater 6 normally used in an installation for preheating the preforms involved in the manufacture of plastic containers. This kind of preform preheating installation according to the present invention preferably comprises heaters 6 consisting of lamps emitting radiation in the infrared spectrum, i.e. infrared lamps. Often, such a preheating installation consists of a succession of independent ovens. In this case, each oven normally comprises several infrared lamps 6, each of the infrared lamps 6 of an oven being able to be independently controlled and protected by a control device according to the present invention.

Specifically, again with reference to FIG. 1, a control device according to the present invention comprises a first power switch 4 connected in series with said heater 6 and a control card 8 for independently regulating the current intensity through the heater 6 by means of the first power switch 4. Typically, a power ranging from 2000 W to 3000 W is delivered to each infrared lamp 6 with an AC voltage ranging from about 360 V to 530 V since the device is normally supplied by an industrial AC power supply 1. The first power switch 4 often consists of a thyristor or an insulated-gate bipolar transistor (IGBT), and serves to regulate the power delivered to the lamp 6. This power switch 4 normally has a thermal capacity, expressed in terms of I²t, lying within the 400 A²s to 900 A²s range, preferably between 550 A²s and 750 A² s, these values being perfectly compatible with the currents flowing through this component during normal operation of the device. As also shown in FIG. 1, the control card 8 is designed to measure the current I and the voltage U in the power switch 4 and can control the latter, for example using the dI/dt signals that it sends thereto, as a function of the setpoints generated by a central control system 9 that are sent to the card 8 via a bus connecting said card 8 to the central control system 9.

As regards the rest of the description, it is clear to a person skilled in the art that, since a preform preheating installation often comprises several independently controllable heaters, the device may similarly comprise several power switches 4 and even several control cards 8, if required, even though this is not specifically indicated.

Moreover, the device according to the present invention is distinguished from the systems known hitherto in that it further includes, depending on the number of infrared lamps 6, at least one detection means 3 connected in series with said heater 6 and with said first power switch 4. The detection means 3 enables the current flowing through it, and possibly the voltage, to be measured, said detection means being connected to the control card 8 that reads this information, as illustrated in FIG. 1. This detection means 3 may in particular consist of a Hall detector.

Next, in particular, at least one second power switch 5 is connected in parallel with said first power switch 4, being connected for example to ground as illustrated in FIG. 1, and may also be controlled by said control card 8. The latter is especially suitable for controlling the second power switch 5 so that, as soon as a current exceeding a predefined threshold value is detected in said detection means 3, the current is diverted into said second power switch 5 instead of passing through the first power switch 4. Specifically, the second power switch 5 consists, again preferably, of a thyristor or an insulated-gate bipolar transistor (IGBT), or indeed any other suitable type of switch. However, the thermal capacity of this second power switch 5 is chosen so that it lies between about 15 000 A²s and 35 000 A²s, depending on the parameters of the other components of the control device. This switch 5 is not used during normal operation and serves merely as a means of protection, especially in the event of a short-circuit occurring, for example when a tungsten filament of an infrared lamp breaks, as mentioned in the introduction. The protection switch 5 enables the short-circuit current to be rapidly diverted because the Hall detector 3, the control card 8 and, for example, a protection thyristor have, altogether, a response time of only the order of a few μs, for example a reaction time of between about 1 μs and 4 μs.

The control device normally also includes at least one electromechanical circuit breaker 2, 7, as a general rule one between each terminal of the power supply 1 and the infrared lamp 6. As shown in FIG. 1, the electromechanical circuit breakers 2, 7 are connected in series with said detection means 3, with said at least one first power switch 4 and with said at least one heater 6, and enable the power supply 1 to be cut off as soon as a current exceeding a threshold value is detected, albeit with a longer reaction time compared with the abovementioned protection thyristors.

Having hitherto described the structure of a control device for a preheating installation according to the present invention, its operation will now be illustrated by describing the corresponding control method for actuating such a control device. This method firstly comprises the step of regulating the current through each heater 6 by means of the first power switch 4, followed by the steps of monitoring the current measured by the detection means 3 and of diverting, as soon as a current exceeding a threshold value is detected in said detection means 3, the current into the second power switch 5 connected in parallel with said first power switch 4. In particular, the control method may include the step of blocking the first power switch 4 and the second power switch 5 at the end of the AC half-cycle during which a current exceeding a threshold value has been detected, and also the step of cutting off the power supply 1 by means of said electromechanical circuit breaker 2, 7 as soon as a current exceeding a threshold value passes through the circuit breaker.

To summarize, the device normally operates by regulating the power delivered to the infrared lamps 6 by means of the control card 8 which for example controls a regulating thyristor or IGBT 4, as known in the prior art. However, instead of using only a fuse or a circuit breaker as protection measure, the present invention proposes to use a second switch, for example a protection thyristor or IGBT 5 that will be sized so as to withstand a short-circuit current. If a short-circuit actually occurs, it is firstly detected by the Hall detector 3, and the control card 8 then controls the protection thyristor 5 by applying a corresponding control current to the inlet of its trigger so as to turn it on. The short-circuit current then preferentially flows via the appropriately sized second switch 5 instead of flowing through the first switch 5, which is sized only for operating under normal conditions. In the case in which the lamps are supplied with AC power, which is the standard case, the regulating thyristor 4 and the protection thyristor 5 are then automatically blocked at the end of the AC half-cycle during which a current exceeding a threshold value has been detected. Finally, depending on the precise reaction time of the circuit breakers 2, 7, at least one of these completely cuts off the power supply 1.

In general, the present invention thus makes it possible, by simple but effective measures, to protect the components of the control device, especially the power switches 4 used for regulating the power of the infrared lamp 6, from the short-circuits that often occur when these lamps break. All of the electronic switches controlling the infrared lamps, and indeed other loads, may be protected by oversized protection thyristors in which the short-circuit current is diverted, after detection of a current threshold, until completion of the cut-off by conventional electromechanical circuit breakers.

Advantageously, it is thus possible for the electronic switches to be effectively protected and for heat not to be continuously generated during normal operation of the device, since the protection thyristors work only if a short-circuit occurs. This is because the thyristors, providing protection and short-circuit current diversion, only work during the short-circuit and remain at a low operating temperature. Consequently, these thyristors have, at the instant of the short-circuit, optimum characteristics for taking a high current.

Likewise, the protection thyristors or IGBTs may be sized according to the physical characteristics of the cut-off equipment located upstream, especially because of their thermal capacity in terms of I²t. Therefore, these thyristors can accept the thermal energy associated with the cut-off power of the circuit breakers or fuses placed upstream in the circuit.

Another advantage of the control device, or indeed the control method, according to the present invention is that the short-circuit is managed over time, owing to the fact that the control card controlling the protection thyristors ensures that the lamp-regulating thyristors and protection thyristors are blocked at the end of the half-cycle during which the short-circuit occurs.

The advantages listed above demonstrate that the present invention makes it possible, by simple and effective measures, to protect the components of a preheating installation using delicate infrared lamps from the effects of short-circuits caused in particular by these lamps breaking.

1. A control device, for controlling at least one heater within an installation for preheating the preforms used in the manufacture of plastic containers, the device comprising:
at least a first power switch connected in series with said at least one heater; and
a control card for independently regulating the current intensity through each heater by means of the corresponding first power switch,
wherein the device comprises:
at least one detection means connected in series with said heater and with said first power switch and enabling the current and/or voltage to be measured; and
at least one second power switch connected in parallel with said first power switch and controlled by said control card,
said control card being designed to divert, as soon as a current exceeding a threshold value is detected in said detection means, the current into said second power switch.

2. The control device as claimed in claim 1, wherein the device is supplied by an AC industrial power supply.

3. The control device as claimed in claim 1, wherein the first power switch and/or the second power switch consist of a thyristor or an insulated gate bipolar transistor (IGBT).

4. The control device as claimed in claim 3, wherein the first power switch has a thermal capacity of between 400 A²s and 900 A²s and the second power switch has a thermal capacity of between 15 000 A²s and 35 000 A²s.

5. The control device as claimed in claim 1, wherein the device includes at least one electromechanical circuit breaker connected in series with said detection means, with said at least one first power switch and with said at least one heater and enabling the power supply to be cut off when a current exceeding a threshold value is detected.

6. The control device as claimed in claim 1, wherein said at least one detection means consists of a Hall detector.

7. The control device as claimed in claim 1, wherein said control card is connected to a central control systems.

8. An installation for preheating the preforms used in the manufacture of plastic containers, which comprises at least one heaters, wherein the installation further comprises at least one control device as claimed in claim 1.

9. The preform preheating installation as claimed in the preceding claim 8, wherein each heater comprises a lamp emitting radiation in the infrared spectrum.

10. The preform preheating installation as claimed in claim 9, wherein the installation consists of a succession of independent ovens, each having at least one lamp emitting radiation in the infrared spectrum, each of the infrared lamps of an oven being able to be independently controlled and protected by said control device.

11. A control method for actuating the control device as claimed in claim 1, respectively for actuating the preheating installation, the method including the step of regulating the current through each heater by means of the corresponding first power switch connected in series with said heaters, wherein the method further includes the steps of:
monitoring the current measured by the detection means connected in series with said heater and said power switch; and
as soon as a current exceeding a threshold value is detected in said detection means, diverting the current into the second power switch connected in parallel with said first power switch.

12. The control method as claimed in claim 11, wherein the method includes the step of blocking the first power switch and the second power switch at the end of the AC half-cycle during which a current exceeding a threshold value has been detected.

13. The control method as claimed in claim 11, wherein the method includes the step of cutting off the power supply by means of said electromechanical circuit breaker as soon as the current flowing through it exceeds a threshold value.

14. The control method as claimed in claim 12, wherein the method includes the step of cutting off the power supply by means of said electromechanical circuit breaker as soon as the current flowing through it exceeds a threshold value.
